(19) United States
(12) Patent Application Publication
(10) Pub. No.: US 2026/0062638 A1
(43) Pub. Date: Mar. 5, 2026

(54) REFRIGERATION OIL AND HEAT PUMP INCLUDING THE SAME

(71) Applicants: SK INNOVATION CO., LTD., Seoul (KR); SK Enmove Co., Ltd., Seoul (KR)

(72) Inventors: Hye Ri KIM, Daejeon (KR); Myoung Lae KIM, Daejeon (KR); Ok Suk LEE, Daejeon (KR); Seong Ho JIN, Daejeon (KR); Geun Ho CHOI, Daejeon (KR)

(21) Appl. No.: 19/295,701

(22) Filed: Aug. 11, 2025

(30) Foreign Application Priority Data
Aug. 29, 2024 (KR) 10-2024-0117074

(51) Int. Cl. C10M 139/04; C09K 5/04; C10M 105/38; C10M 171/00; C10N 40/30; F25B 30/02

(52) U.S. Cl. CPC C10M 139/04; C09K 5/044; C10M 105/38; C10M 171/008; F25B 30/02; C09K 2205/122; C10M 2207/2835; C10M 2227/04; C10N 2040/30

(57) ABSTRACT

A refrigeration oil according to embodiments of the present disclosure includes a silane compound having at least one of a glycidyl group and an isocyanate group. The heat pump according to embodiments of the present disclosure includes a refrigerant including trifluoroiodomethane (R-1311) and the refrigeration oil including a silane compound having at least one of a glycidyl group and an isocyanate group.

### CROSS-REFERENCE TO RELATED APPLICATIONS

This patent application claims the priority and benefits of Korean Patent Application No. 10-2024-0117074 filed on Aug. 29, 2024, the disclosure of which is incorporated herein by reference in its entirety.

### BACKGROUND

### 1. Field of the Invention

The embodiments of the present disclosure generally relate to a refrigeration oil and a heat pump including the same.

### 2. Description of the Related Art

Recently, various types of heat pumps used indoors and outdoors have been developed, and due to the development of electric vehicles, etc., miniaturized heat pumps are increasingly in demand. The heat pump is provided with a refrigerant circulation system including a compressor, a condenser, expansion mechanisms such as expansion valves, an evaporator and the like. In the refrigerant circulation system, the phenomenon in which heat is absorbed from the surroundings during the vaporization of a liquid is utilized, and a cycle is repeated, including compression and temperature increase of the vaporized refrigerant in the compressor, condensation and heat release in the condenser resulting in liquefaction of the refrigerant, pressure reduction and expansion in the expansion mechanisms, and vaporization of the refrigerant in the evaporator.

In addition to the refrigerant, the refrigerant circulation system is filled with a refrigeration oil for lubricating sliding parts of the compressor. The refrigeration oil is designed to achieve the desired performance when filled in the refrigerant circulation system, and in this case, considering compatibility with the refrigerant becomes important. For example, a refrigeration oil with poor compatibility with the refrigerant may not return to the sliding parts of the compressor during circulation in the refrigerant circulation system due to incompatibility with the refrigerant, and there is a concern that this may result in a reduction in lubricity.

In order to better meet these performance requirements, in the case of hydrofluorocarbon (HFC) refrigerants, refrigeration lubricants mainly composed of oxygen-containing organic compounds such as a vinyl ether compound and polyoxyalkylene glycol are generally used. In order to further improve the stability and lubrication performance of the refrigeration lubricants, various additives are commonly added to the refrigeration lubricants mainly composed of oxygen-containing organic compounds.

### SUMMARY

An embodiment of the present disclosure provides a refrigeration oil with enhanced chemical stability at high temperatures and/or high pressures.

Another embodiment of the present disclosure provides a heat pump including the refrigeration oil with enhanced chemical stability at high temperatures and/or high pressures. A refrigeration oil according to embodiments of the present disclosure includes a silane compound having at least one of a glycidyl group and an isocyanate group.

According to some embodiments the silane compound having a glycidyl group may include a silane compound represented by Formula 1 below.

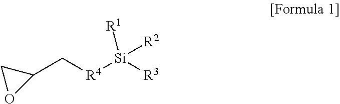

In Formula 1, R¹ to R⁴ may each independently be an organic group having 1 to 10 carbon atoms.

According to some embodiments R¹ to R³ may each independently be an alkyl group or an alkoxy group having 1 to 10 carbon atoms.

According to some embodiments the silane compound having an isocyanate group may include a silane compound represented by Formula 2 below.

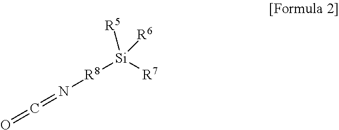

In Formula 2, R⁵ to R⁷ may each independently be an organic group having 1 to 10 carbon atoms, and R⁸ may be an alkylene group having 1 to 10 carbon atoms.

According to some embodiments R⁵ to R⁷ may each independently be an alkyl group or an alkoxy group having 1 to 10 carbon atoms.

According to some embodiments the refrigeration oil may further include a stabilizer including a phosphate compound.

According to some embodiments the stabilizer may include at least one of trimethylphosphate, triethylphosphate, tributylphosphate, tris(methylphenyl) phosphate, and triphenylphosphate.

According to some embodiments the refrigeration oil may further include a lubricant.

According to some embodiments the lubricant may include a polyol ester.

The refrigeration oil according to embodiments of the present disclosure may exhibit enhanced chemical stability at high temperatures and/or high pressures.

A heat pump system according to embodiments of the present disclosure may include a refrigerant including trifluoroiodomethane (R-1311) and the refrigeration oil.

According to some embodiments the heat pump may include a heat pump system comprising a compressor configured to compress the refrigerant, a condenser adapted to transfer heat from the refrigerant to an external environment, an expansion device configured to reduce the pressure of the refrigerant, an evaporator adapted to absorb heat from a heat source and transfer it to the refrigerant.

According to some embodiments the refrigeration oil maintains compatibility with the refrigerant to enhance system efficiency, reduce wear on mechanical components of the heat pump system.

According to some embodiments the refrigerant further comprises at least one more refrigerant selected from the group of natural refrigerants, hydrofluorocarbon (HFC)-based refrigerants, hydrofluoroolefin (HFO)-based refrigerants, and hydrochlorofluorocarbon (HCFC)-based refrigerants.

A refrigerant composition according to embodiments of the present disclosure may include the refrigeration oil, trifluoroiodomethane (R-1311), and at least one more refrigerant selected from the group of natural refrigerants, hydrofluorocarbon (HFC)-based refrigerants, hydrofluoroolefin (HFO)-based refrigerants, and hydrochlorofluorocarbon (HCFC)-based refrigerants.

The heat pump system according to embodiments of the present disclosure may include the refrigeration oil exhibiting enhanced chemical stability at high temperatures and/or high pressures.

The refrigeration oil of the present disclosure may be used in eco-friendly heat pumps, etc., that use a refrigerant including trifluoroiodomethane (R-1311) to prevent climate change by suppressing air pollution and greenhouse gas emissions.

### BRIEF DESCRIPTION OF THE DRAWINGS

The above and other objects, features and other advantages of the embodiments of the present disclosure will be more clearly understood from the following detailed description taken in conjunction with the accompanying drawings, in which:

FIGS. 1 and 2 are schematic views illustrating the flow of a refrigerant for heat exchange in a cooling mode or a heating mode of a heat exchanger according to one embodiment of the present disclosure, respectively; and

FIG. 3 is a photograph showing refrigeration oil of Example 1 following the ASHRAE 97 evaluation.

FIG. 4 is a photograph showing refrigeration oil of Example 2 following the ASHRAE 97 evaluation.

FIG. 5 is a photograph showing refrigeration oil of Example 4 following the ASHRAE 97 evaluation.

FIG. 6 is a photograph showing refrigeration oil of Comparative Example 1 following the ASHRAE 97 evaluation.

FIG. 7 is a photograph showing refrigeration oil of Comparative Example 2 following the ASHRAE 97 evaluation.

FIG. 8 is a photograph showing refrigeration oil of Comparative Example 3 following the ASHRAE 97 evaluation.

### DETAILED DESCRIPTION

According to embodiments of the present disclosure, a refrigeration oil including a silane compound is provided. Also, according to embodiments of the present disclosure a refrigerant including trifluoroiodomethane (R-1311) and the refrigeration oil is provided.

It has been found, rather unexpectedly that adding the refrigeration oil with a silane compound in a refrigerant containing trifluoroiodomethane (R-1311) results in significant enhancement of the chemical stability of the refrigerant at high temperatures and/or high pressures.

Hereinafter, embodiments of the present disclosure will be described in detail. However, these are merely illustrative and the embodiments of the present disclosure are not limited to the specific embodiments described by way of example.

The term “organic group” as used herein may refer to a substituent that includes only carbon and hydrogen, or that includes carbon and hydrogen along with one or more heteroatoms. The term “heteroatom” as used herein may refer to an atom other than carbon and/or hydrogen. For example, an heteroatom may be nitrogen (N), oxygen (O), phosphorus (P), sulfur(S), etc.

The term “substituted” as used herein may refer to a state in which at least one of hydrogen atoms in a compound is substituted with a substituent, such as a halogen group, a hydroxyl group, a heteroalkyl group, a heterocycloalkyl group, a heteroaryl group, an amine group, a nitrile group, a nitro group, a silyl group, etc.

The term “unsubstituted” as used herein may refer to a state in which all hydrogen atoms of a compound are not substituted, i.e., remain unsubstituted.

The term “alkyl group” as used herein may refer to a straight or branched alkyl group having 1 to 10 carbon atoms, unless otherwise defined in the relevant section.

The term “cycloalkyl group” as used herein may refer to a functional group derived by removing one hydrogen atom from a cycloalkane having 1 to 10 carbon atoms, unless otherwise defined in the relevant section.

The term “aryl group” as used herein may refer to a functional group derived by removing one hydrogen atom from an aromatic hydrocarbon having 6 to 10 carbon atoms, unless otherwise defined in the relevant section.

The term “alkylene group” as used herein may refer to a functional group derived by removing two hydrogen atoms from a straight or branched alkyl group having 1 to 10 carbon atoms, unless otherwise defined in the relevant section.

The refrigeration oil according to embodiments of the present disclosure includes a silane compound having at least one of a glycidyl group and an isocyanate group.

According to some embodiments the silane compound may serve as an acid scavenger. Further, the silane compound may additionally function as a moisture scavenger. The refrigeration oil may be used together with a refrigerant in a heat exchange system (e.g., a heat pump). In such a case, the silane compound may function to remove acid generated due to decomposition of the refrigerant during operation of the system. By including the silane compound, the refrigeration oil may exhibit enhanced chemical stability at high temperatures and/or high pressures.

According to embodiments of the present disclosure, since the silane compound includes a glycidyl group as a functional group, its acid and moisture scavenging abilities may be further enhanced.

According to embodiments of the present disclosure, since the silane compound includes an isocyanate group as a functional group, its acid and moisture scavenging abilities may be further enhanced.

According to some embodiments the refrigeration oil may be used together with a refrigerant including trifluoroiodomethane (R-1311). Trifluoroiodomethane (R-1311) is a type of hydrofluorocarbon (HFC) refrigerant, and has an ozone depletion potential (ODP) of 0 and a global warming potential (GWP) of less than 5. Accordingly, a refrigerant including trifluoroiodomethane (R-1311) may exhibit enhanced environmental friendliness due to the trifluoroiodomethane (R-1311) included in the refrigerant.

However, the trifluoroiodomethane (R-1311) may react with moisture due to its reactivity to generate acid. Accordingly, discoloration of the refrigeration oil, formation of sludge, and corrosion of metal may occur due to oxidation of the refrigerant or refrigeration oil. In addition, the generation of acid may accelerate the decomposition of trifluoroiodomethane (R-1311). According to some embodiments of the present disclosure, the refrigeration oil of the examples includes a silane compound as an acid scavenger for removing the acid generated by decomposition of the refrigerant.

According to some embodiments the silane compound may be included in an amount of 5% by weight (“wt %”) or less, or 0.1 wt % to 5 wt %, or 1 wt % to 5 wt %, or 1 wt % to 3 wt %, or 1 wt % to 2 wt % based on the total weight of the refrigeration oil. When the silane compound is included in an amount of 5 wt % or less based on the total weight of the refrigeration oil, a decrease in the lubricating performance of the refrigeration oil may be prevented. In addition, the chemical stability of the refrigeration oil including trifluoroiodomethane (R-1311), which is a refrigerant, may be further enhanced, for example, by preventing iodine contained in the trifluoroiodomethane (R-1311) from attaching to metal surfaces.

According to some embodiments the silane compound having a glycidyl group may include a silane compound represented by Formula 1 below.

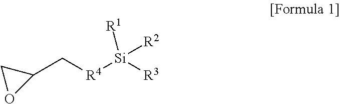

In Formula 1, R¹ to R³ may each independently be an organic group having 1 to 10 carbon atoms, or an organic group having 1 to 8 carbon atoms, or an organic group having 1 to 5 carbon atoms.

For example, R¹ to R³ may each independently be an alkyl group or an alkoxy group having 1 to 10 carbon atoms; an alkyl group or an alkoxy group having 1 to 8 carbon atoms; or an alkyl group or an alkoxy group having 1 to 5 carbon atoms.

In Formula 1, R⁴ may be an organic group having 1 to 10 carbon atoms, or an organic group having 1 to 8 carbon atoms, or an organic group having 1 to 5 carbon atoms.

For example, R⁴ may be an alkylene group having 1 to 10 carbon atoms, or an alkylene group having 1 to 8 carbon atoms, or an alkylene group having 1 to 5 carbon atoms, which includes at least one heteroatom.

According to some embodiments the silane compound having a glycidyl group may include 3-(glycidyloxypropyl) trimethoxysilane represented by Formula 1-1 below.

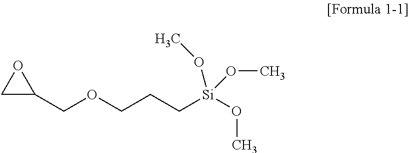

According to some embodiments the silane compound having an isocyanate group may include a silane compound represented by Formula 2 below.

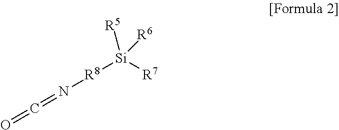

In Formula 2, R⁵ to R⁷ may each independently be an organic group having 1 to 10 carbon atoms, or an organic group having 1 to 8 carbon atoms, or an organic group having 1 to 5 carbon atoms.

For example, R⁵ to R⁷ may each independently be an alkyl group or an alkoxy group having 1 to 10 carbon atoms; an alkyl group or an alkoxy group having 1 to 8 carbon atoms; or an alkyl group or an alkoxy group having 1 to 5 carbon atoms.

In Formula 2, R⁸ may be an alkylene group having 1 to 10 carbon atoms, or an alkylene group having 1 to 8 carbon atoms, or an alkylene group having 1 to 5 carbon atoms.

According to some embodiments the silane compound having an isocyanate group may include 3-isocyanatopropyltrimethoxysilane represented by Formula 2-1 below.

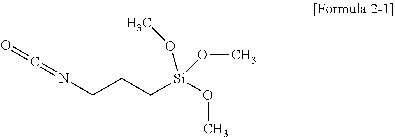

According to some embodiments the refrigeration oil may further include a stabilizer. For example, the stabilizer may include a thiazole-based compound, a triazole-based compound, a thiadiazole-based compound, etc. For example, the stabilizer may include a phosphate-based compound. For example, the phosphate-based compound may include trimethylphosphate, triethylphosphate, tributylphosphate, tris(methylphenyl) phosphate, triphenylphosphate, etc. Accordingly, by preventing the decomposition of the refrigerant and the refrigeration oil, as well as oxidation of the refrigeration oil, etc., the chemical stability of the refrigeration oil at high temperatures and/or high pressures may be further enhanced.

The refrigeration oil may further include an amine-based phosphate compound, particularly an amine-based phosphate compound having 10 or more carbon atoms. Accordingly, the chemical stability of the refrigeration oil at high temperatures and/or high pressures may be further enhanced.

The stabilizer may be included in an amount of 0.5 wt % to 3 wt %, 0.5 wt % to 2 wt %, or 1 wt % to 2 wt % based on the total weight of the refrigeration oil. When the refrigeration oil includes the stabilizer in an amount of 3 wt % or less, the initial total acid number (TAN) of the refrigeration oil may be prevented from becoming excessively high, thereby further enhancing the chemical stability of the refrigeration oil.

According to some embodiments the refrigeration oil may further include a lubricant. For example, the lubricant may include paraffin, naphthene, aromatic hydrocarbon, benzene or naphthalene, substituted or unsubstituted with linear or branched alkyl groups, polyester, polyol ester, polyvinyl ether, and the like. For example, the lubricant may include an alkylated naphthalene. The alkylated naphthalene may be monoalkyl naphthalene, dialkyl naphthalene, trialkyl naphthalene, tetraalkyl naphthalene, or a mixture thereof.

For example, the lubricant may include a polyol ester. Examples of a polyol ester may include di-polyol ester, such as neopentyl glycol esters, and tri-polyol ester, such as trimethylolpropane esters. Polyol esters may be favored because of their biodegradability, low toxicity, and environmentally friendly characteristics.

The lubricant may be included in an amount of 70 wt % to 99 wt %, 80 wt % to 98.5 wt %, 90 wt % to 98 wt %, or 91 wt % to 97.5 wt % based on the total weight of the refrigeration oil.

The refrigeration oil according to embodiments may further include an antioxidant, a defoaming agent, a load-bearing additive, a chlorine scavenger, a detergent-dispersant, a viscosity index improver, an oiliness agent, a rust inhibitor, a pour point depressant, an extreme pressure additive, and the like.

For example, the antioxidant may be a phenolic or amine-based antioxidant. The phenolic antioxidant may include 2,6-di-tert-butyl-4-methylphenol (DBPC), 2,6-di-tert-butyl-4-ethylphenol, 2,2′-methylenebis(4-methyl-6-tert-butylphenol), 2,4-dimethyl-6-tert-butylphenol, 2,6-di-tert-butylphenol, etc. The amine-based antioxidant may include N,N′-diisopropyl-p-phenylenediamine, N,N′-di-sec-butyl-p-phenylenediamine, phenyl-α-naphthylamine, N,N′-diphenyl-p-phenylenediamine, etc.

For example, the defoaming agent may be a homopolymer or copolymer of acrylic ester.

For example, the extreme pressure additive may include an extreme pressure additive of an organosulfur compound, a phosphorothioate ester-based extreme pressure additive, an ester-based extreme pressure additive, an organochlorine-based extreme pressure additive, an organofluorine-based extreme pressure additive, an alcohol-based extreme pressure additive, an extreme pressure additive of a metal compound, etc. The extreme pressure additive of an organosulfur compound may include monosulfides, polysulfides, sulfoxides, sulfones, thiosulfinates, sulfurized oils, thiocarbonates, thiophenes, thiazoles, methanesulfonates, etc. The ester-based extreme pressure additive may include higher fatty acids, hydroxyaryl fatty acids, polyol esters, acrylates, etc. The organochlorine-based extreme pressure additive may include chlorinated hydrocarbons or chlorinated carboxylic acid derivatives, etc. The organic fluorine-based extreme pressure additive may include fluorinated aliphatic carboxylic acids, fluoroethylene resins, fluoroalkyl polysiloxanes, fluorinated graphite, etc. The extreme pressure additive of a metal compound may include naphthenates (such as lead naphthenic acid), fatty acid salts (such as lead fatty acid salts), thiophosphates (such as zinc dialkyldithiophosphate), thiocarbamates, organic molybdenum compounds, organic tin compounds, organic germanium compounds, etc.

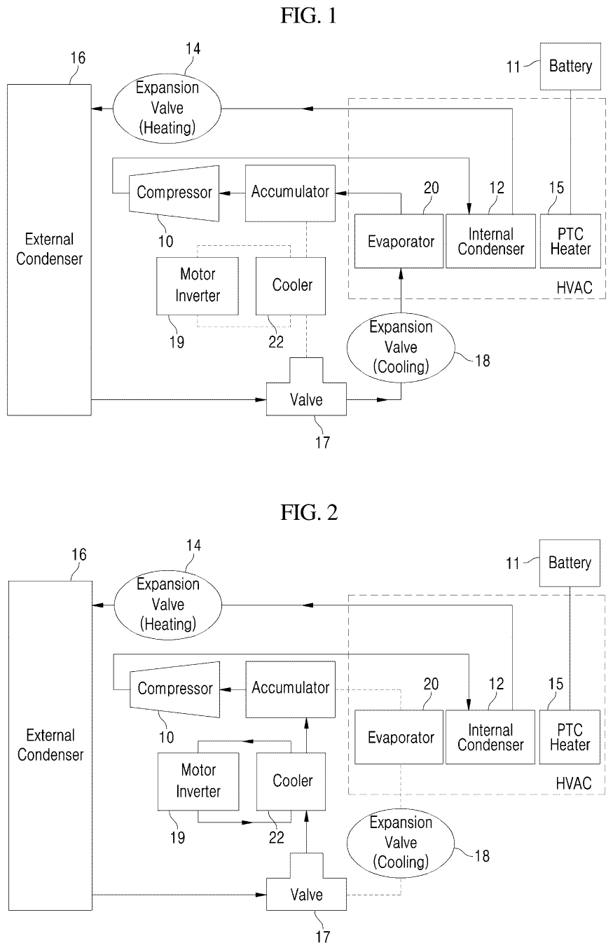

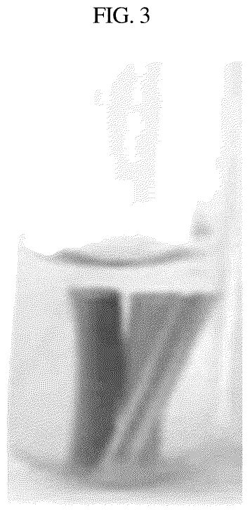

FIGS. 1 and 2 are schematic views illustrating the flow of a refrigerant for heat exchange in a cooling mode or a heating mode of a heat exchanger according to one embodiment of the present disclosure, respectively.

In FIGS. 1 and 2, the directions of the arrows indicate the flow path of the refrigerant.

Referring to FIG. 1, in the cooling mode, the refrigerant is compressed through a compressor 10, bypasses an internal condenser 12 and an expansion valve 14 (heating) in turn, releases heat in an external condenser 16, then expands through the expansion valve 18 (cooling), and reabsorbs heat through an evaporator 20.

Referring to FIG. 2, in the heating mode, the refrigerant is compressed through the compressor 10, releases heat in the internal condenser 12, expands through the expansion valve 14 (heating), absorbs heat from the external condenser 16, and then further absorbs heat through a cooler 22.

The heat pump according to embodiments of the present disclosure includes a refrigerant including trifluoroiodomethane (R-1311) and the refrigeration oil. Accordingly, the heat pump may improve refrigeration performance while enhancing environmental friendliness and stability.

The heat pump may include a compressor, a condenser, an expansion valve and an evaporator. In the compressor, the above-described refrigerant may be compressed to a high temperature and high pressure state, and in the expansion valve, the above-described refrigerant may be expanded to a low temperature and low pressure state.

For example, the above-described refrigerant may release heat or absorb heat while circulating through the compressor, condenser, expansion valve and evaporator inside the heat pump. The refrigerant may be maintained in a gaseous state at high temperature and high pressure in the compressor. The refrigerant may be liquefied into a liquid state by releasing heat in the condenser. The refrigerant may be maintained in a low temperature and low pressure liquid state, or in a mixed state of liquid and gas in the expansion valve. The refrigerant may absorb heat in the evaporator and vaporize into a gaseous state.

In some embodiments, a coefficient of performance (COP) of the heat pump may be 1 to 10. The coefficient of performance (COP) refers to the ratio of the amount of heat effectively gained to the amount of work input when operating the heat pump.

A highly efficient heat pump having the coefficient of performance within the above range may be provided using the above-described refrigerant.

According to embodiments, the refrigerant including trifluoroiodomethane (R-1311) may further include natural refrigerants, hydrofluorocarbon (HFC)-based refrigerants, hydrofluoroolefin (HFO)-based refrigerants, hydrochlorofluorocarbon (HCFC)-based refrigerants, etc.

The natural refrigerants may include methane (R-50), ammonia (R-717), carbon dioxide (R-744), ethane (R-170), propane (R-290), propylene (R-1270), isobutane (R-600a), dimethyl ether, isopentane, pentane, etc.

The hydrofluorocarbon (HFC) refrigerants may include difluoromethane (R-32), 1,1-difluoroethane (R-152a), pentafluoroethane (R-125), 1,1,1,2-tetrafluoroethane (R-134a), 1,1,1-trifluoroethane (R-143a), trifluoromethyl methyl ether (RE143a), trifluoromethane (R-23), fluoroethane (R-161), octafluoropropane (R-218), 1,1,1,2,3,3,3-heptafluoropropane (R-227ea), 1,1,1,2,3,3-hexafluoropropane (R-236ea), 1,1,1,3,3,3-hexafluoropropane (R-236fa), 1,1,1,3,3-pentafluoropropane (R-245fa), octafluorocyclobutane (RC318), 1,1,1,3,3-pentafluorobutane (R-365mfc), etc.

The hydrofluoroolefin (HFO) refrigerants may include 1,1,2-trifluoroethylene (R-1123), 1-chloro-2,3,3,3-tetrafluoropropene (R1224yd (Z)), 2,3,3,3-tetrafluoropropene (R-1234yf), 1,3,3,3-tetrafluoropropene (R-1234ze), 1,2,3,3-tetrafluoropropene (R-1234ye), 3,3,3-trifluoropropene (R-1243zf), 1,1-difluoroethylene (R-1132a), 1,2,3,3,3-pentafluoropropene (R-1225ye), etc.

The hydrochlorofluorocarbon (HCFC) refrigerants may include difluorochloromethane (R-22), chlorotetrafluoroethane (R-124), 1-chloro-1,1-difluoroethane (R-142b), etc.

Hereinafter, experimental examples including specific examples and comparative examples are proposed to facilitate understanding of the embodiments of the present disclosure. However, the following examples are only given for illustrating the embodiments and are not intended to limit the appended claims. It will be apparent to those skilled in the art that various alterations and modifications are possible within the scope and technical concepts of the present disclosure, and such alterations and modifications are duly included in the appended claims. Furthermore, the embodiments may be combined to form additional embodiments.

### EXAMPLES AND COMPARATIVE EXAMPLES

Refrigeration oils of examples and comparative examples were prepared according to the compositions described in Table 1 below.

TABLE 1

| | | Alkylated | Acid scavenger | | |
|---|---|---|---|---|---|
| Classifi- | POE | naphthalene | | Content | Stabilizer |
| cation | (wt %) | (wt %) | Component | (wt %) | (wt %) |
| Example 1 | 95 | 2 | A1 | 1.5 | 1.5 |
| Example 2 | 91.5 | 2 | A1 | 5 | 1.5 |
| Example 3 | 89.5 | 2 | A1 | 7 | 1.5 |
| Example 4 | 95 | 2 | A2 | 1.5 | 1.5 |
| Example 5 | 91.5 | 2 | A2 | 5 | 1.5 |
| Example 6 | 89.5 | 2 | A2 | 7 | 1.5 |
| Comparative | 100 | — | — | — | — |
| Example 1 | | | | | |
| Comparative | 95 | 2 | B | 1.5 | 1.5 |
| Example 2 | | | | | |
| Comparative | 93.5 | 2 | B | 3 | 1.5 |
| Example 3 | | | | | |

* POE: (Synastive ES 4068, BASF)
* Alkylated naphthalene (Synesstic 5, Exxon mobil)
* Phosphate: tris(methylphenyl) phosphate (RC 3661, Lanxess)
* A1: Silane compound represented by Formula 1-1
* A2: Silane compound represented by Formula 2-1
* B: 2-Ethylhexyl glycidyl ether (CAS 2461-15-6)

### Experimental Example: ASHRAE 97 Evaluation

The refrigeration oil, CF₃I, copper (Cu), aluminum (Al) and iron (Fe) catalysts of the examples were introduced into a sealed tube, and exposed to an environment of 175° C. for 14 days, and then subjected to the following evaluation.

In the case of Comparative Example 1, the following evaluation was performed under the same conditions as the above examples, except that the components were exposed to an environment of 150° C.

In the case of Comparative Examples 2 and 3, the following evaluation was performed under the same conditions as the above examples, except that the components were exposed to an environment of 160° C.

### 1) Measurement of Total Acid Number (TAN)

TAN was measured in accordance with the ASTM D664 method using a 686 Titroprocessor (Metrohm).

### 2) Measurement of ASTM Color

The color was measured in accordance with the ASTM D1500 method using a LICO 500 spectral colorimeter (HACH LANGE).

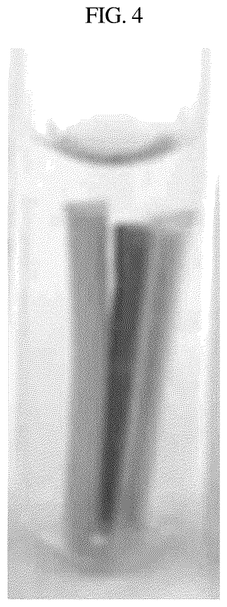

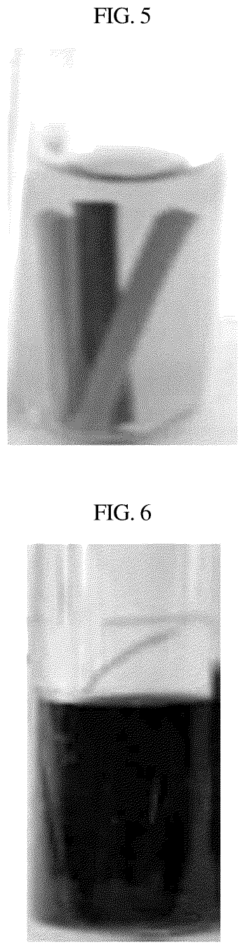

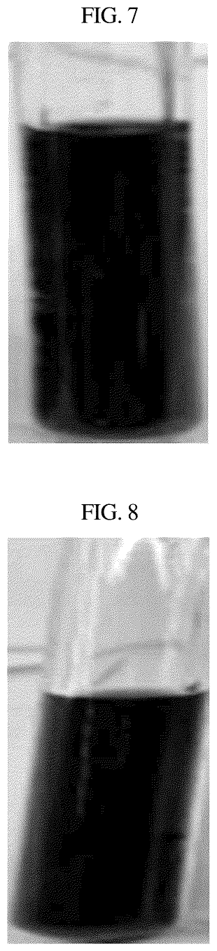

FIGS. 3 to 5 are photographs showing the refrigeration oils of Examples 1, 2 and 4, and FIGS. 6 to 8 are photographs showing the refrigeration oils of Comparative Examples 1, 2 and 3, respectively, after ASHRAE 97 evaluation.

The evaluation results of the experimental examples for the refrigeration oils of Examples 1 to 6 and Comparative Examples 1 to 3 are shown in Table 2 below.

TABLE 2

| | ASHRAE 97 (after 14 days of exposure) | | |
|---|---|---|---|
| | Temperature | | |
| Refrigerant oil | (° C.) | TAN after evaluation | ASTM color |
| Example 1 | 175 | 0.47 | <0.5 |
| Example 2 | 175 | 0.48 | <0.5 |
| Example 3 | 175 | 0.51 (Metal discoloration | 1 |
| | | & Precipitate formation) | |
| Example 4 | 175 | 0.85 | 1 |
| Example 5 | 175 | 0.96 | 1.5 |
| Example 6 | 175 | 1.21 (Metal discoloration) | 2 |
| Comparative | 150 | >15 | >8 |
| Example 1 | | | |
| Comparative | 160 | 8.2 (Precipitate formation) | 7 |
| Example 2 | | | |
| Comparative | 160 | 5.38 (Metal discoloration) | 6 |
| Example 3 | | | |

Referring to FIGS. 3 to 8, the refrigeration oils of Examples 1, 2, and 4 showed less color change even under a higher temperature (175° C.) environment, and thus exhibited better chemical stability at high temperatures than the refrigeration oils of the comparative examples.

Referring to Table 2, the refrigeration oils of the examples exposed to a higher temperature (175° C.) had TAN values of 1.3 or lower, while the refrigeration oils of the comparative examples exposed to a lower temperature (150° C.) had TAN values of 5 or higher, 10 indicating that the refrigeration oils of the examples containing silane compounds exhibited better acid scavenging capabilities.

The refrigeration oils of the examples had ASTM color values of 2 or lower, while the refrigeration oils of the comparative examples had ASTM color values of 6 or higher.

Accordingly, the refrigeration oil of the examples using silane compounds as acid scavengers exhibited better chemical stability at high temperatures.

1. A refrigeration oil comprising:
a silane compound having at least one of a glycidyl group and an isocyanate group.

2. The refrigeration oil according to claim 1, wherein the silane compound having the glycidyl group is represented by Formula 1 below: 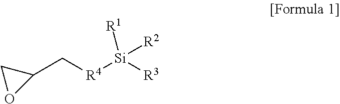
wherein in Formula 1, R¹ to R⁴ are each independently an organic group having 1 to 10 carbon atoms.

3. The refrigeration oil according to claim 2, wherein R¹ to R³ are each independently an alkyl group or an alkoxy group having 1 to 10 carbon atoms.

4. The refrigeration oil according to claim 1, wherein the silane compound having an isocyanate group is represented by Formula 2 below: 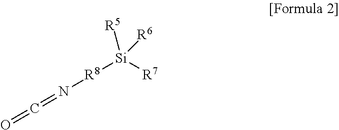
wherein in Formula 2, R⁵ to R⁷ are each independently an organic group having 1 to 10 carbon atoms, and R⁸ is an alkylene group having 1 to 10 carbon atoms.

5. The refrigeration oil according to claim 4, wherein R⁵ to R⁷ are each independently an alkyl group or an alkoxy group having 1 to 10 carbon atoms.

6. The refrigeration oil according to claim 1, further comprising a stabilizer including a phosphate compound.

7. The refrigeration oil according to claim 6, wherein the stabilizer comprises at least one of trimethylphosphate, triethylphosphate, tributylphosphate, tris(methylphenyl) phosphate, and triphenylphosphate.

8. The refrigeration oil according to claim 1, further comprising a lubricant.

9. The refrigeration oil according to claim 8, wherein the lubricant comprises a polyol ester.

10. A heat pump comprising:
a refrigerant comprising trifluoroiodomethane (R-1311); and
the refrigeration oil of claim 1.

11. The heat pump of claim 10, the heat pump comprising a heat pump system comprising:
a compressor configured to compress the refrigerant;
a condenser adapted to transfer heat from the refrigerant to an external environment;
an expansion device configured to reduce the pressure of the refrigerant;
an evaporator adapted to absorb heat from a heat source and transfer it to the refrigerant;
wherein the refrigeration oil maintains compatibility with the refrigerant to enhance system efficiency, reduce wear on mechanical components of the heat pump system.

12. The heat pump of claim 11, wherein the refrigerant further comprises at least one more refrigerant selected from the group of natural refrigerants, hydrofluorocarbon (HFC)-based refrigerants, hydrofluoroolefin (HFO)-based refrigerants, and hydrochlorofluorocarbon (HCFC)-based refrigerants.

13. A refrigerant composition comprising the refrigeration oil of claim 1, trifluoroiodomethane (R-1311), and at least one more refrigerant selected from the group of natural refrigerants, hydrofluorocarbon (HFC)-based refrigerants, hydrofluoroolefin (HFO)-based refrigerants, and hydrochlorofluorocarbon (HCFC)-based refrigerants.
